(19) United States
(12) Patent Application Publication
(10) Pub. No.: US 2012/0208722 A1
(43) Pub. Date: Aug. 16, 2012

(54) SURFACE ENHANCED RAMAN SPECTROSCOPY PLATFORMS AND METHODS

(76) Inventors: RICHARD DLUHY, Athens, GA (US); GEERT-JAN BOONS, Athens, GA (US); SHARON MARTIN, Athens, GA (US); Jun Guo, Athens, GA (US); Xiuru Li, Athens, GA (US)

(21) Appl. No.: 13/276,695

(22) Filed: Oct. 19, 2011

Related U.S. Application Data
(60) Provisional application No. 61/394,529, filed on Oct. 19, 2010.

(51) Int. Cl. G01N 21/65; C40B 30/10; C40B 40/04

(52) U.S. Cl. 506/12; 436/94; 422/82.05; 506/15

(57) ABSTRACT

Surface enhanced Raman spectroscopy (SERS) platforms and methods of making and using such platforms are disclosed herein. Such platforms can be made by immobilizing a biomaterial (e.g., a carbohydrate such as a glycan) by reacting an azide-functional group attached to a surface of a solid substrate with at least one cyclooctyne (e.g., a dibenzocyclooctyne) having a biomaterial or biomaterial binding group attached thereto. In certain embodiments the immobilized biomaterial can be detected using, for example, surface enhanced Raman spectroscopy.

This application claims the benefit of U.S. Provisional Application No. 61/394,529, filed Oct. 19, 2010, which is hereby incorporated by reference in its entirety.

### GOVERNMENT FUNDING

The present invention was made with government support under a grant from the National Institutes for Health (Grant No. 1R01GM090269-01). The Government has certain rights in this invention.

### BACKGROUND

Almost all cell surfaces and secreted proteins are modified by covalently-linked carbohydrate moieties and the glycan structures on these so-called glycoproteins have been implicated as essential mediators in processes such as protein folding, cell signaling, fertilization, embryogenesis, neuronal development, hormone activity, and the proliferation of cells and their organization into specific tissues. In addition, overwhelming data supports the relevance of glycosylation in pathogen recognition, inflammation, innate immune responses, and the development of autoimmune diseases and cancer.

Glycomics is an emerging field of integrated research to study structure-function relationships of complex carbohydrates. However, progress in this field of research has been hampered by, among other things, the difficulty in fabricating microarrays of synthetic glycans useful, for example, for elucidating pathways of glycoconjugate biosynthesis.

Thus, there is a continuing, unmet need for new carbohydrate arrays and convenient methods for making such carbohydrate arrays.

### SUMMARY

In one aspect, the present disclosure provides methods for preparing surface enhanced Raman spectroscopy (SERS) platforms. In certain embodiments, the methods disclosed herein provide a carbohydrate array (e.g., a microarray) that can be used for a wide variety of uses including, for example, detection of immobilized carbohydrates (e.g., using surface enhanced Raman spectroscopy, SERS) to provide data for the diagnosis of a disease or state.

In one embodiment, the method for preparing surface enhanced Raman spectroscopy (SERS) platforms can include: providing a solid substrate (e.g., a particle or rod) including a surface having attached thereto a plurality of azide-functional groups; and contacting at least a portion of the azide-functional groups with at least one cyclooctyne having a biomaterial (e.g., a carbohydrate such as a glycan) attached thereto under conditions effective for a cycloaddition reaction to form a triazole having the biomaterial attached thereto.

In another embodiment, the method for preparing surface enhanced Raman spectroscopy (SERS) platforms can include: providing a solid substrate (e.g., a particle or rod) including a surface having a plurality of triazole conjugate groups attached thereto, wherein the triazole conjugate groups are reaction products of (i) azide-functional groups attached to the surface of the substrate and (ii) cyclooctynes having a biomaterial binding group attached thereto; and contacting the biomaterial binding groups with the biomaterial under conditions effective to bind (e.g., using affinity binding) and immobilize the biomaterial.

For certain embodiments of the above disclosed methods, the cyclooctyne can be a dibenzocyclooctyne. Suitable dibenzocyclooctynes include those of the formula:

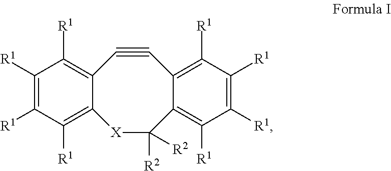

wherein: each R¹ is independently selected from the group consisting of hydrogen, halogen, hydroxy, alkoxy, nitrate, nitrite, sulfate, and a C₁-C₁₀ organic group; each R² is independently selected from the group consisting of hydrogen, halogen, hydroxy, alkoxy, nitrate, nitrite, sulfate, and a C₁-C₁₀ organic group; X represents C═O, C═N—OR³, C═N—NR³R⁴, CHOR³, CHNHR³, BR³, NR³, O, SiR³R⁴, PR³, O═PR³ or halogen; and each R³ and R⁴ independently represents hydrogen or an organic group, with the proviso that at least one R group is attached to the biomaterial or biomaterial binding group. In certain embodiments, each R¹ represents hydrogen. In other certain embodiments, each R² represents hydrogen. In additional embodiments, X represents CHOR³ and R³ is an organic linking group attached to the biomaterial or biomaterial binding group.

The above disclosed methods can optionally further include detecting the at least one immobilized biomaterial using, for example, surface enhanced Raman spectroscopy. In certain embodiments, detection of the at least one immobilized biomaterial can provide data for the diagnosis of a disease or state.

In another aspect, the present disclosure provides surface enhanced Raman spectroscopy (SERS) platforms. In some embodiments, the platform includes: a solid substrate including a surface; and a plurality of triazole conjugate groups attached to the surface, wherein the triazole conjugate groups are reaction products of (i) azide-functional groups attached to the surface of the substrate and (ii) cyclooctynes having a biomaterial attached thereto. The solid substrate can include one or more of a wide variety of materials such as polymers, glasses, metals, plastics, oxides, or combinations thereof. The solid substrate can be in a wide variety of forms including, for example, particles (e.g., microparticles and/or nanoparticles) or rods (e.g., microrods and/or nanorods). In certain embodiments, the platform can optionally include two or more different biomaterials. In other certain embodiments, the platform can optionally include a plurality of polar groups (e.g., polyethylene glycol-containing groups) and/or a plurality of hydrophobic groups (e.g., C1-C30 hydrocarbon-containing groups) attached to the surface.

### DEFINITIONS

The term “comprises” and variations thereof do not have a limiting meaning where these terms appear in the description and claims.

As used herein, “a,” “an,” “the,” “at least one,” and “one or more” are used interchangeably.

As used herein, the term “or” is generally employed in the sense as including “and/or” unless the context of the usage clearly indicates otherwise.

Also herein, the recitations of numerical ranges by endpoints include all numbers subsumed within that range (e.g., 1 to 5 includes 1, 1.5, 2, 2.75, 3, 3.80, 4, 5, etc.).

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 illustrates exemplary structures for (A) a compound for attaching to a surface and having azide functionality (N₃AT); (B) a compound for attaching to a surface and having polar and non-polar segments (MEG); (C) a biotin-functional dibenzocyclooctyne (BDIBO); and (D) a trizole reaction product of the azide-functional group with a dibenzocyclooctyne.

FIG. 2 illustrates an exemplary SERS Spectra of MEG and different molar ratios of MEG:N₃AT.

FIG. 3 illustrates an exemplary SERS Spectra of BDIBO.

FIG. 4 illustrates an exemplary SERS Spectra of the Clicked biotinylated gold nanoparticles.

FIG. 5 illustrates an exemplary UV-Vis spectra of Biotinylation process of gold nanoparticles.

FIG. 6 illustrates an exemplary UV-Vis spectra of avidin timed Studies.

FIG. 7 illustrates an exemplary UV-Vis spectra of neutravidin timed studies.

FIG. 8 illustrates an exemplary SERS spectra of avidin.

FIG. 9 illustrates an exemplary averaged SERS spectra of avidin and neutravidin timed studies.

FIG. 10 illustrates an exemplary averaged SERS spectra of neutravidin timed studies.

FIG. 11 illustrates an exemplary SERS spectra of the use of BSA as a blocking agent for avidin-biotin studies.

FIG. 12 illustrates an exemplary SERS spectra of the use of BSA as a blocking agent for MEG:N₃AT-avidin studies.

FIG. 13 illustrates exemplary PCA plots of MEG:N₃AT:BDIBO (Biotin; dark triangles) and MEG:N₃AT:BDIBO-Avidin (Biotin-Avidin; light spots).

FIG. 14 illustrates exemplary PCA plots of MEG (spacer group; dark triangles) MEG-Avidin (light spots).

FIG. 15 illustrates exemplary PCA plots of the use of BSA as a blocking agent for biotin-avidin experiments.

FIG. 16 illsuprates exemplary PCA plots of the use of BSA as a blocking agent for MEG:N₃AT-avidin experiments, with MEG:N₃AT:BDIBO (Biotin; dark triangles), MEG:N₃AT:BDIBO-BSA (Biotin-BSA; light+signs), and MEG:N₃AT:BDIBO-BSA-avidin (Biotin-BSA-Avidin; dark squares).

FIG. 17 illustrates exemplary PLS-DA plots of biotin-avidin (top plot; biotin is dark triangles; biotin-avidin is light+signs) and MEG-avidin (bottom plot; MEG is dark triangles; MEG-avidin is hollow diamonds).

FIG. 18 illustrates exemplary PCA plots of the use of BSA as a blocking agent for three models of biotin-avidin experiments, with Biotin (dark triangles), Biotin-BSA (light+signs), and Biotin-BSA-Avidin (dark squares).

FIG. 19 illustrates an exemplary plots of the use of BSA as a blocking agent for three models of MEG:N₃AT-avidin experiments, with MEG:N₃AT (dark triangles), MEG:N₃AT-BSA (light+signs), and MEG:N₃AT-BSA-Avidin (dark squares).

FIG. 20 illustrates an exemplary SERS spectra of a galactose-functional dibenzocyclooctyne (Gal-DIBO).

FIG. 21 illustrates exemplary SERS spectra for the triazole products formed from the reaction of Gal-DIBO with an azide-functional group.

### DETAILED DESCRIPTION OF ILLUSTRATIVE EMBODIMENTS

Surface enhanced Raman spectroscopy (SERS) technology based on label-free detection of immobilized biomaterials on platforms using surface enhanced Raman spectroscopy is disclosed herein. As used herein, the term “biomaterials” is intended to encompass biomolecules such as proteins, nucleic acids, lipids, and saccharides including for example, carbohydrates such as glycans. In certain embodiments, the surface enhanced Raman spectroscopy platforms are carbohydrate arrays (e.g., glycan microarrays) that have been prepared using Cu-free click reactions to modify a solid surface with oligosaccharide ligands as further discussed herein below.

Bioorthogonal reactions are reactions of materials with each other, wherein each material has limited or substantially no reactivity with functional groups found in vivo. The efficient reaction between an azide and a terminal alkyne, i.e., the most widely studied example of “click” chemistry, is known as a useful example of a bioorthogonal reaction. In particular, the Cu(I) catalyzed 1,3-dipolar cyclization of azides with terminal alkynes to give stable triazoles (e.g., Binder et al., Macromol. Rapid Commun. 2008, 29:952-981) has been employed for tagging a variety of biomolecules including proteins, nucleic acids, lipids, and saccharides. The cycloaddition has also been used for activity-based protein profiling, monitoring of enzyme activity, and the chemical synthesis of microarrays and small molecule libraries.

An attractive approach for installing azides into biomolecules is based on metabolic labeling whereby an azide containing biosynthetic precursor is incorporated into biomolecules using the cells' biosynthetic machinery. This approach has been employed for tagging proteins, glycans, and lipids of living systems with a variety of reactive probes. These probes can facilitate the mapping of saccharide-selective glycoproteins and identify glycosylation sites. Alkyne probes have also been used for cell surface imaging of azide-modified bio-molecules and a particularly attractive approach involves the generation of a fluorescent probe from a non-fluorescent precursor by a [3+2] cycloaddition. Despite the apparent utility of reacting an azide with a terminal alkyne, applications in biological systems using this reaction have been practically limited by factors including the undesirable presence of a copper catalyst.

To expand the scope of glycan microarrays, a new methodology for label free detection of biomolecules using Surface-Enhanced Raman Spectroscopy (SERS) is disclosed. In this approach, novel Cu-free click reactions via strain promoted azide alkyne cycloaddition, can be employed to modify a solid surface of gold or silver substrates with biomolecules such as carbohydrates. For example, carbohydrates can be modified with a disulfide containing linker for attachment to a substrate surface. The substrate surface can be formed from any suitable material, including but not limited to polymers, glass, metal, plastic, oxides, and the like. The method can include attaching biomolecules to substrates (e.g., gold or silver) by modifying the surface with a monolayer of dibenzocycloctynes. For example, the linker can have a disulfide moiety for attachment to silver or gold, a hydrophobic alkane region to encourage monolayer formation, a polar PEG moiety to facilitate compatibility with an aqueous environment, and a cyclooctyne for click chemistry. Binding events can be monitored in a label free manner by SERS.

This technique can be advantageous over methods currently used for glycan array technology. First, normal 1,3-cycloaddition click chemistry uses a copper catalyst which is toxic to bacterial and mammalian cells. The presently disclosed method does not require such a catalyst, therefore avoiding the toxicity of using the copper catalyst. Second, SERS is a preferred method for detecting binding events compared to fluorescence, Surface Plasmon Resonance (SPR), and Mass Spectrometry. SERS is molecule specific, label free, can differentiate between specific and nonspecific binding events, and valuable chemical information can be gained. In comparison, fluorescence requires the use of fluorescent labels (which may interfere with carbohydrate binding), photobleaching, broad overlapping emission bands, and uncertain bioinformatic approaches for interpretation of fluorescent intensity maps in microarrays; Mass Spectrometry typically is not suitable for studying carbohydrate binding events; and SPR cannot readily differentiate between specific and nonspecific binding events.

Surface enhanced Raman spectroscopy (SERS) technology based on label-free detection of immobilized biomaterials on platforms using surface enhanced Raman spectroscopy is disclosed herein. In certain embodiments, the surface enhanced Raman spectroscopy platforms are carbohydrate arrays (e.g., glycan microarrays) that have been prepared using Cu-free click reactions to modify a solid surface with oligosaccharide ligands as further discussed herein below.

In one embodiment, the method can include: providing a solid substrate (e.g., a particle or rod) including a surface having attached thereto a plurality of azide-functional groups; and contacting at least a portion of the azide-functional groups with at least one cyclooctyne having a biomaterial (e.g., a carbohydrate such as a glycan) attached thereto under conditions effective for a cycloaddition reaction to form a triazole having the biomaterial attached thereto.

In another embodiment, the method can include: providing a solid substrate (e.g., a particle or rod) including a surface having a plurality of triazole conjugate groups attached thereto, wherein the triazole conjugate groups are reaction products of (i) azide-functional groups attached to the surface of the substrate and (ii) cyclooctynes having a biomaterial binding group attached thereto; and contacting the biomaterial binding groups with the biomaterial under conditions effective to bind (e.g., using affinity binding) and immobilize the biomaterial.

In certain embodiments, the carbohydrate can be bound using affinity binding. For example, the carbohydrate binding group can include a biotin group, and the carbohydrate can include avidin and/or streptavidin. The solid substrate can include one or more of a wide variety of materials such as polymers, glasses, metals (e.g., Au and Ag), plastics, oxides, or combinations thereof. The solid substrate can be in a wide variety of forms including, for example, particles (e.g., magnetic or non-magnetic microparticles and/or nanoparticles) or rods (e.g., microrods and/or nanorods). In certain embodiments, such substrates can be in the form of three-dimensional matrices or scaffolds. Exemplary three-dimensional matrices include, but are not limited to, those available under the trade designations ALGIMATRIX 3D Culture system, GELTRIX matrix, and GIBCO three-dimensional scaffolds, all available from Invitrogen (Carlsbad, Calif.). Such three-dimensional matrices can be particularly useful for applications including cell cultures.

An exemplary azide-functional group is of the formula R⁸—N₃ (e.g., represented by the valence structure R⁸—^{-N—N═N}⁺), wherein R⁸ represents and organic group that can be attached to the solid substrate. For example, azide-functional groups can be attached to a Ag or Au surface when the R⁸ group has a terminal thiol or disulfide functionality.

In the above disclosed methods, the carbohydrate can be, for example, a glycan. The term “glycan” as used herein is inclusive of both oligosaccharides and polysaccharides, and includes both branched and unbranched polymers. When the carbohydrate component contains a carbohydrate that has three or more saccharide monomers, the carbohydrate can be a linear chain or it can be a branched chain. In a preferred embodiment, the carbohydrate component contains less than about 15 saccharide monomers; more preferably in contains less than about 10 saccharide monomers.

For certain embodiments of the above disclosed methods, the cyclooctyne can be a dibenzocyclooctyne. Suitable dibenzocyclooctynes include those of the formula:

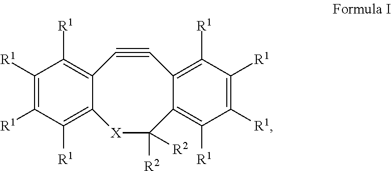

wherein: each R¹ is independently selected from the group consisting of hydrogen, halogen, hydroxy, alkoxy, nitrate, nitrite, sulfate, and a C₁-C₁₀ organic group; each R² is independently selected from the group consisting of hydrogen, halogen, hydroxy, alkoxy, nitrate, nitrite, sulfate, and a C₁-C₁₀ organic group; X represents C═O, C═N—OR³, C═N—NR³R⁴, CHOR³, CHNHR³, BR³, NR³, O, SiR³R⁴, PR³, O═PR³ or halogen; and each R³ and R⁴ independently represents hydrogen or an organic group, with the proviso that at least one R group is attached to the biomolecule or biomolecule binding group. In certain embodiments, each R¹ represents hydrogen. In other certain embodiments, each R² represents hydrogen. In additional embodiments, X represents CHOR³ and R³ is an organic linking group attached to the biomolecule or biomolecule binding group.

As used herein, the term “organic group” is used for the purpose of this invention to mean a hydrocarbon group that is classified as an aliphatic group, cyclic group, or combination of aliphatic and cyclic groups (e.g., alkaryl and aralkyl groups). In the context of the present invention, suitable organic groups for compounds of this invention are those that do not interfere with the reaction of an alkyne with an azide-functional compound to form a triazole. In the context of the present invention, the term “aliphatic group” means a saturated or unsaturated linear or branched hydrocarbon group. This term is used to encompass alkyl, alkenyl, and alkynyl groups, for example. The term “alkyl group” means a saturated linear or branched monovalent hydrocarbon group including, for example, methyl, ethyl, n-propyl, isopropyl, tert-butyl, amyl, heptyl, and the like. The term “alkenyl group” means an unsaturated, linear or branched monovalent hydrocarbon group with one or more olefinically unsaturated groups (i.e., carbon-carbon double bonds), such as a vinyl group. The term “alkynyl group” means an unsaturated, linear or branched monovalent hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.).

As a means of simplifying the discussion and the recitation of certain terminology used throughout this application, the terms “group” and “moiety” are used to differentiate between chemical species that allow for substitution or that may be substituted and those that do not so allow for substitution or may not be so substituted. Thus, when the term “group” is used to describe a chemical substituent, the described chemical material includes the unsubstituted group and that group with nonperoxidic O, N, S, Si, or F atoms, for example, in the chain as well as carbonyl groups or other conventional substituents. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, tert-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, tert-butyl, and the like.

Alkynes of Formula I are typically strained, cyclic alkynes. Surprisingly it has been found that alkynes of Formula I as described herein (e.g., wherein X represents C═O, C═N—OR³, C═N—NR³R⁴, CHOR³, or CHNHR³; and each R³ and R⁴ independently represents hydrogen or an organic group) have been found to have higher reactivity towards 1,3-dipole-functional compounds than other strained, cyclic alkynes (e.g., wherein X represents CH₂). See, for example, U.S. Pat. Application Publication No. 2010/0297250A1 (Boons et al.) for further examples of dibenzycyclooctynes and the preparation thereof.

The above disclosed methods can optionally further include detecting the at least one immobilized biomolecule using, for example, surface enhanced Raman spectroscopy. See, for example, U.S. Pat. Nos. 7,880,876 B2 (Zhao et al.), 7,889,334 B2 (Krause et al.), and 7,940,387 B2 (Dluhy et al.); and U.S. Pat. Application Publication No. 2010/0268473 A1 (Tripp et al.). In certain embodiments, detection of the at least one immobilized biomolecule can provide data for the diagnosis of a disease or state.

In another aspect, the present disclosure provides surface enhanced Raman spectroscopy (SERS) platforms. In some embodiments, the platform includes: a solid substrate including a surface; and a plurality of triazole conjugate groups attached to the surface, wherein the triazole conjugate groups are reaction products of (i) azide-functional groups attached to the surface of the substrate and (ii) cyclooctynes having a biomaterial attached thereto. The solid substrate can include one or more of a wide variety of materials such as polymers, glasses, metals, plastics, oxides, or combinations thereof. The solid substrate can be in a wide variety of forms including, for example, particles (e.g., microparticles and/or nanoparticles) or rods (e.g., microrods and/or nanorods). In certain embodiments, the platform can optionally include two or more different biomaterials. In other certain embodiments, the platform can optionally include a plurality of polar groups (e.g., polyethylene glycol-containing groups) and/or a plurality of hydrophobic groups (e.g., C1-C30 hydrocarbon-containing groups) attached to the surface.

One or more cyclic alkynes can be contacted with the azide-functional groups under conditions effective to react in a cyclization reaction and form a triazole. Preferably, conditions effective to form the triazole can include the substantial absence of added catalyst such as a Cu(I) catalyst. Conditions effective to form the triazole can also include the presence or absence of a wide variety of solvents including, but not limited to, aqueous (e.g., water) and non-aqueous solvents; protic and aprotic solvents; polar and non-polar solvents; and combinations thereof. The triazole can be formed over a wide temperature range, with a temperature range of 0° C. to 40° C. (and in some embodiments 23° C. to 37° C.) being particularly useful when biomolecules are involved. Conveniently, reaction times can be less than one day, and sometimes one hour or even less.

The present invention is illustrated by the following examples. It is to be understood that the particular examples, materials, amounts, and procedures are to be interpreted broadly in accordance with the scope and spirit of the invention as set forth herein.

### EXAMPLES

Cu(I)-free cycloaddition reactions were employed to examine the Biotin-Avidin system via Surface Enhanced Raman spectroscopy (SERS). Biotin is a small molecule around 244 Da (Diamandis et al., Clin. Chem. 1991, 37:625). Avidin is a 67-kDa glycoprotein which consists of four identical subunits (Delange et al., J. Biol. Chem. 1971, 246:698). The biotin-avidin affinity is around 10¹⁵ mol⁻¹ making it one of the strongest bindings between a protein and ligand ever reported. It has been used for many bioanalytical applications, and therefore, was chosen to show the versatility of Cu(I)-free cycloaddition reactions to serve as a multifunctional array.

### Reagents

ACS grade ethanol, Phosphate Buffer Saline (pH=7.4), and (11-Mercaptoundecyl)tetra(ethylene glycol) were purchased from Sigma Aldrich. Dimethylformamide was purchased from JT. Baker and Sterile Water was purchased from Braun.

### Preparation of Substrate

Highest Grade V1 mica sheets were purchased from Ted Pella Inc. A Thermionics Vacuum Evaporator was used to prepare gold substrates. Substrates were prepared by evaporation of ˜300 nm of gold (99.99% purity) onto mica sheets at a rate of 1 Å/s. After thermal evaporation, substrates were flame annealed and cut into 1×1 cm chips.

### Preparation of Clicked Biotin Nanoparticles

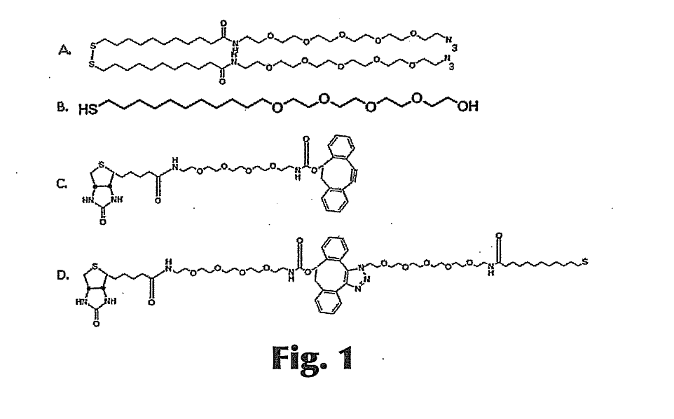

Structures of compounds are shown in FIG. 1. Gold nanoparticles were functionalized with Azides by placing them in a solution of MEG/N₃AT, which were dissolved in DMF, for 12 hours under stirring. After this period of time, the gold nanoparticle solution was purified by centrifugation to remove any excess MEG/N₃AT. Biotinylation, of the now MEG/N₃AT nanoparticles occurred by adding a 2 mM solution of BDIBO for 12 hours. Following the 12 hour period, this biotinylated gold nanoparticles were purified by centrifugation. The particles were resuspended into nanopure water obtained from a Barnstead Nanopure water purification system.

### Characterization Techniques

UV-Vis. IN-visible absorption spectra were recorded on a Beckman Coulter DU800UV/Visible spectrophotometer using a 1 cm path length quartz cuvette.

Fluorescence Measurements. Samples were spotted into a 96 well microplate from Greiner Bio-One. Fluorescence measurements were recorded on a POLARstat OPTIMA multidetection microplate reader.

SERS Measurements. SERS measurements were obtained using a Renishaw in Via confocal Raman microscope system equipped with a 785 nm near-infrared diode laser as the excitation source. The incident laser beam was delivered to the sample through a 20× (NA=0.40) objective onto an automated sample stage. The laser spot is approximately 4.8×27.8 μm. The laser power was set to 1%, where the power at the sample surface was measured to be approximately 3.5 mW. Twenty microliters of each sample were spotted onto gold covered mica substrates. Five-ten spectra were recorded from different locations on the substrate. Acquisition settings were 5 accumulations for 10 seconds each.

### Data Analysis

SERS spectra were averaged then baseline corrected using GRAMS32/A1 Version 6.0 spectral software package. Raw SERS spectra were pre-processed for chemometric analysis using the first derivative of each spectrum and a 15 point, 2^{nd} order polynomial Savistky-Golay algorithm followed by normalization to unit vector length with Matlab software to allow direct intensity comparison between samples and between variables within a sample. Principle component analysis (PCA) was used to examine clustering of similar spectra using PLS tool box 4.0. Partial least squares discriminate analysis (PLS-DA) models were built to classify samples as well. PLS-DA models were processed by first taking the derivative of each spectrum and a 15 point, 2^{nd} order polynomial Savistky-Golay algorithm followed by normalization to unit vector length with Matlab software. The normalized first derivative spectra were then mean-centered prior to PLS-DA. The robustness of the models created by PLS-DA was tested by cross-validation (CV) with Venetian Blinds.

### Determination of a Suitable Ratio of MEG and N₃AT

To begin this study, a suitable ratio of MEG and N₃AT was determined to ensure clicking will take place. In the present scheme, MEG serves as a spacer compound to dilute the number of azides on the surface. This is desirable because, if each of the self-assembling compounds contains an azide moiety, the recognition and binding of BDIBO will less likely occur. This is because a densely packed monolayer of all azides would block each other, preventing the binding of BDIBO (Knoll et al., J. Colloid Surf. A-Physicochem. Eng. Asp. 2000, 161:115).

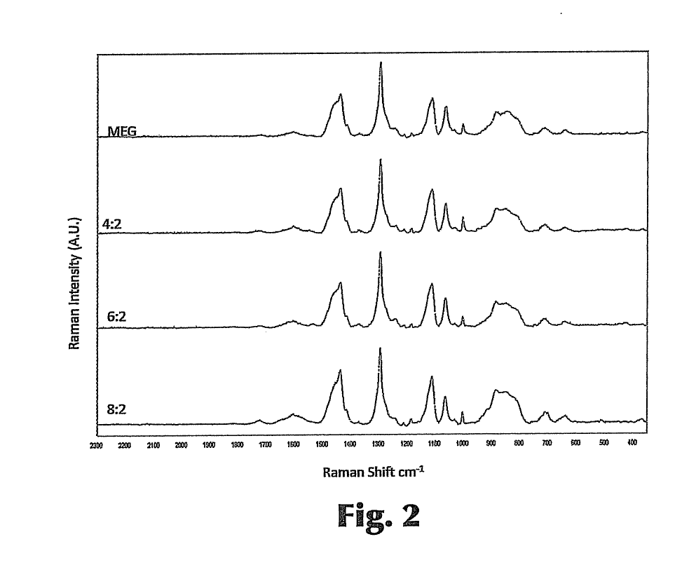

Molar ratios of MEG:N₃AT used were 8:2, 6:2, and 4:2. SERS spectra were taken of MEG followed by the mixed ratios of MEG:N₃AT. The spectra can be seen in the FIG. 2. MEG and N₃AT have similar structures. Therefore, it is not surprising that spectra MEG and MEG:N₃AT are similar. Assignments can be seen in Table 1.

TABLE 1
Assignment of the SERS bands in the spectra of MEG and
MEG:N₃AT

| WAVENUMBER | ASSIGNMENT |
|---|---|
| 638 | v(C—S)G |
| 712 | v(C—S)T |
| 803 | CH₂ rocking |
| 843 | CH₂ rocking |
| 885 | CH₂ rocking |
| 1000 | v(C—C) |
| 1062 | v(C—O) stretching |
| 1114 | CH₂ twisting |
| 1297 | v(C—O) stretching |
| 1438 | v(C—H) stretching |
| 1457 | v(C—H) stretching |

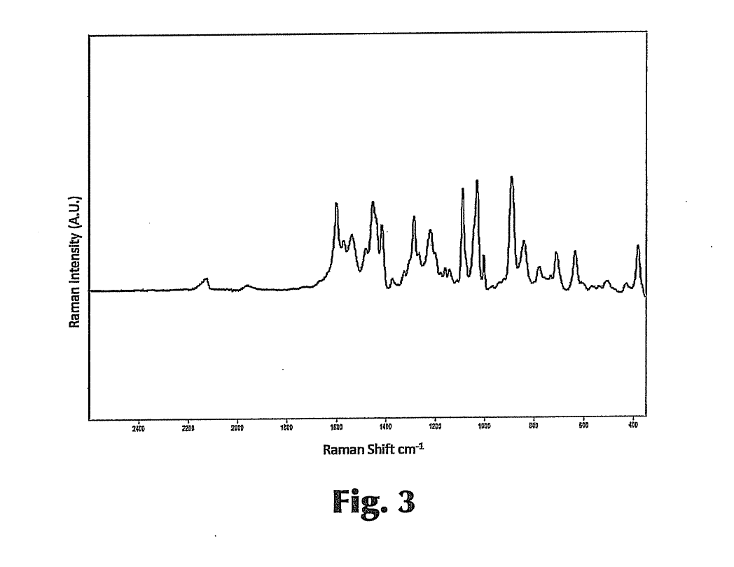

Biotin was clicked onto the functionalized surface using BDIBO. To understand what features can be attributed to the BDIBO moiety, a SERS spectrum was taken of this compound. The spectrum can be seen in the FIG. 3. It should be noted, that the orientation of BDIBO as a free compound is different from how it would be once it is clicked onto the functionalized azide surface. Therefore, spectral features will appear different once BDIBO is clicked to the azide surface. However, there are some spectral characteristics that will be similar to both spectral orientations. Characteristic spectral features that are of interest are the region between 1900-2200 wavenumber (cm⁻¹). These bands can be attributed to ≡C—C vibrations. These peaks for ≡C—C will disappear when BDIBO clicks to the azide functionalized surface.

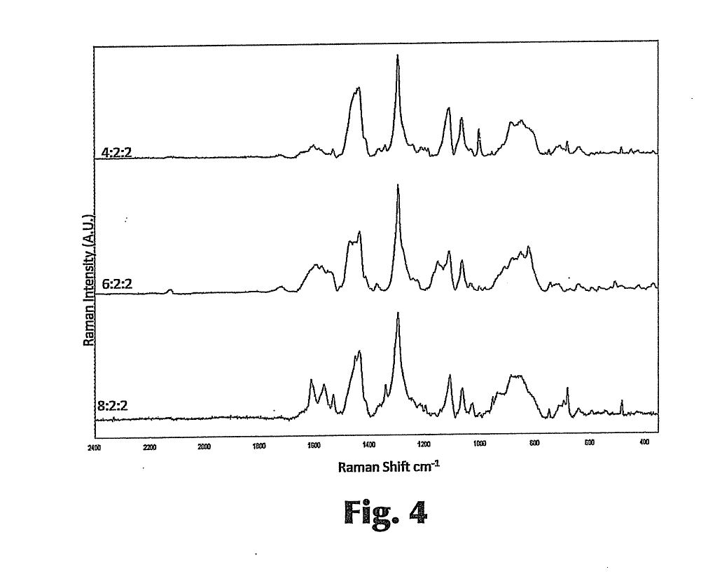

The SERS spectra of the clicked biotin product are shown in FIG. 4. Examination of the clicked biotin spectra reveals several things. First, in the spectra for the ratios of 4:1 and 8:1, there is an appearance of bands around 485, 679, 744, 951, 1021, 1563, and 1612 cm⁻¹. These bands can be assigned to the BDIBO compound. In these spectra, evidence that clicked chemistry occurred can be seen in the disappearance of the bands for ≡C—C vibrations and the appearance of bands for the formation of triazole around 1340 and 1530 cm⁻¹. It should be noted that there is no evidence that clicking of BDIBO occurred in the ratio of 6:1. The spectrum contains ≡C—C vibrations and no bands for the BDIBO compound appear. Spectral assignment can be seen in Table 2. Based on these results the ratio of 8:1 was chosen for further experiments.

TABLE 2
Assignment of the SERS bands in the spectra
of the clicked biotin complex.

| WAVENUMBER | ASSIGNMENT |
|---|---|
| 485 | BDIBO |
| 641 | MEG |
| 679 | BDIBO |
| 709 | MEG |
| 744 | BDIBO |
| 850 | MEG |
| 887 | MEG |
| 950 | BDIBO |
| 1002 | MEG |
| 1021 | BDIBO |
| 1061 | MEG |
| 1103 | MEG |
| 1296 | MEG |
| 1335 | Triazole |
| 1436 | MEG |
| 1448 | MEG |
| 1529 | Triazole |
| 1563 | BDIBO |
| 1612 | BDIBO |

### Avidin Capture by Clicked Biotin Nanoparticles

Avidin-FITC was used to examine the capturing ability of the clicked biotin nanoparticles. Avidin-FITC was purchased from Invitrogen. To a microcentrifuge tube, 500 μL of clicked biotin nanoparticles were placed in a PBS buffer. To this solution 250 μL it of Avidin-FITC was added. Initial studies investigated binding times of Avidin-FITC to the clicked biotin nanoparticles. Binding times chosen were 15, 30, and 60 minutes. All experiments were carried out at 4° C. Following the binding times, all samples were purified by centrifuging the samples 2-3 times for twenty minutes. Since the avidin purchased contains a fluorescent label in FITC at a ratio of 1:1, fluorescence experiments as well as SERS were used to examine avidin binding. Using this relationship the concentration of avidin captured by the biotinylated nanoparticles can be estimated from a standard fluorescence curve. A standard fluorescence curve of avidin-FITC in PBS was generated to estimate the amount of avidin captured onto the nanoparticles.

It is well known that a major problem with avidin in some cases is high nonspecific binding. This problem can be attributed to presence of sugars mannose and N-acetylglucosamine on the backbone structure of avidin and the high isoelectric point of avidin (Delange et al., J. Biol. Chem. 1971, 246:698). Therefore, nanoparticles containing only MEG were also reacted with avidin to determine examine nonspecific binding of avidin. The values of the fluorescence response for the standard curve can be seen in Table 3. The table also includes the response of the unknown samples which are from the timed binding experiments. The table shows that as expected, when biotin is present, the fluorescence response for avidin is enhanced. The fluorescence response recorded when avidin is present is over 11 times greater when only MEG is present. It can also be gathered that the binding times of biotin-avidin are not necessarily important for significant binding to occur. In the 15 minute time frame relevant binding occurred, therefore, it was chosen for future experiments. It also is not surprising that the fluorescence response for the MEG nanoparticles is over 5 times higher than the control, PBS. This may be due to the high nonspecific biding of avidin.

TABLE 3
Fluorescent standard curve responses and fluorescent
values for timed studies.

| | AVIDIN CONCENTRATON |
|---|---|
| FLUORESCENCE | (micromolar) |
| 18498 | 0.44 |
| 3014 | 0.11 |
| 754 | 0.0275 |
| 191 | 6.88E−03 |
| 61 | 1.72E−03 |
| 29 | 4.40E−03 |
| 22 | PBS 0 |
| 1241 | Biotin-15 minutes Avidin |
| 723 | Biotin-30 minutes Avidin |
| 1089 | Biotin-60 minutes Avidin |
| 105 | Avidin-15 minutes MEG |

In addition to avidin, neutravidin was also used in similar timed binding experiments. The same binding times of 15, 30, and 60 minutes were used and the fluorescence response was measured. Neutravidin is a modified form avidin that does not contain carbohydrates. Therefore, it has low nonspecific binding properties (Vermette et al., J. Colloid Interface Sci. 2003, 259:13). Neutravidin-FITC was purchased from Invitrogen. The fluorescence responses for the timed studies of neutravidin are shown in Table 4. It should be noted that the avidin and neutravidin concentrations are the same for both binding experiments. Comparison of the fluorescence response values for avidin and neutravidin indicate lower values for neutravidin. This may stem from the lower nonspecific binding of neutravidin.

TABLE 4
Fluorescent values for timed studies of neutravidin.

| FLUORESCENCE | NEUTRAVIDIN SAMPLE |
|---|---|
| 316 | Biotin-15 minutes Neutravidin |
| 570 | Biotin-30 minutes Neutravidin |
| 625 | Biotin-60 minutes Neutravidin |

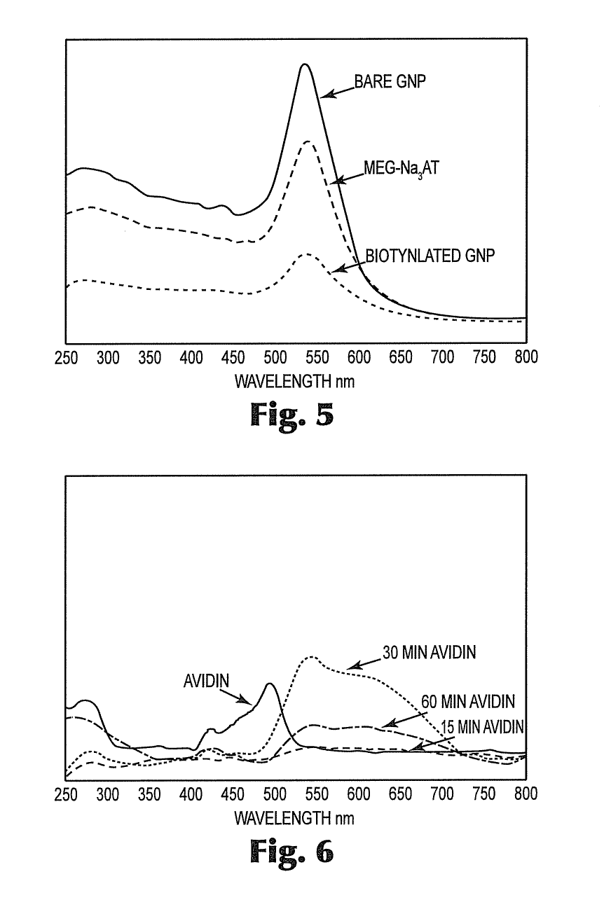

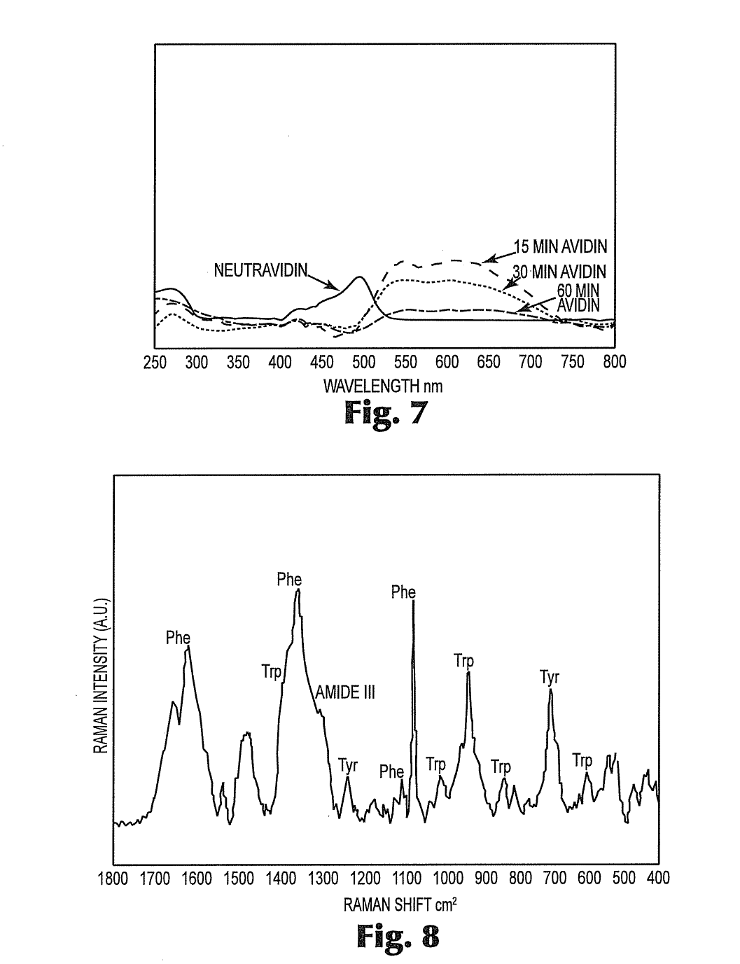

In addition to fluorescence, these samples were also analyzed by UV-Vis absorption spectroscopy. The spectra can be seen in FIGS. 5-7. UV-Vis also allowed the derivation process to be followed step by step. Spectra were taken of the bare gold nanoparticles, derivatization with MEG:N₃AT, addition of BDIBO, and, avidin binding. Upon addition of MEG:N₃AT to the gold nanoparticles, there is a slight red shift in the surface Plasmon of the nanoparticle. This shift is indicates that the nanoparticle has been derivatized in some manner. These results are consistent with previous studies (Mayya et al., Langmuir 1997, 13:3944). When biotynlation occurs, the peak if broadened and shortened. The addition of avidin causes the nanoparticles to aggregate and in the spectra this is seen by the significant broadening of the surface plasmon of the nanoparticle. This is expected because avidin has up to four binding sights for biotin. Therefore, crosslinking between biotinylated nanoparticles can occur as has been previously reported (Sastry et al., Langmuir 1998, 14:4138). As a reference, the UV-Vis spectrum of avidin was taken. The presence of avidin of absorption in the spectra can be seen around 280 nm in all of the spectra containing avidin.

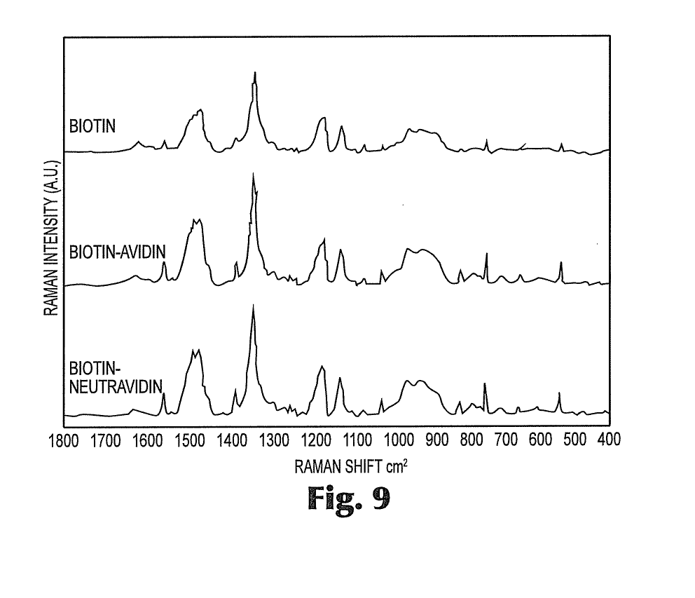

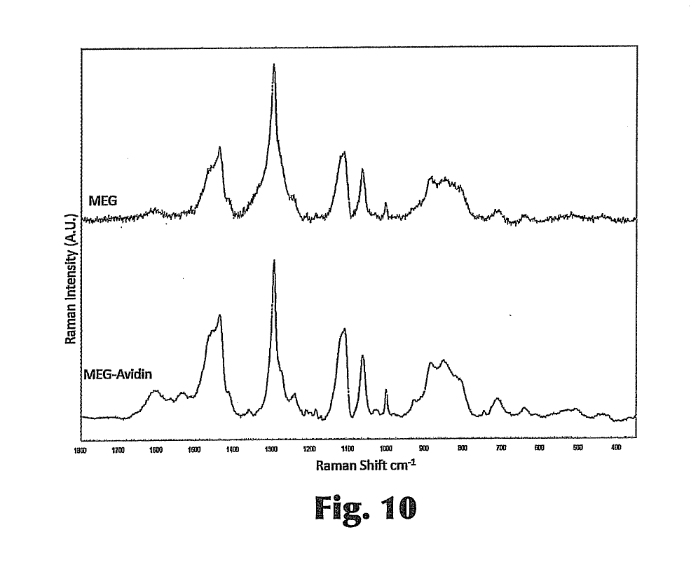

Further characterization of the derivatized nanoparticles was done by SERS. To begin, a SERS spectrum of avidin was taken as a reference for spectral assignments. This spectrum is seen in FIG. 8. SERS spectra of the timed avidin and neutravidin studies as well as MEG-avidin were taken as well. The averaged spectra are shown in the FIG. 9-10. Several spectral comparisons were examined. The avidin bands which appear in the spectra are: Phe (1027 cm⁻¹), Trp (542, 755, and 1359 cm⁻¹), and Amide III (1236) (Han et al., Anal. Chem. 2009, 81:3329).

A number of observations can be made from the spectra presented. The SERS bands for avidin appear to be weak in the spectra. Previous studies have shown that the avidin signals can produce a very high background (Ahern et al., Langmuir 1991, 7:254). One reason for this observation is due to the small amount of avidin captured onto the biotinylated nanoparticles. The concentration of the captured avidin can be estimated from the fluorescence data. The estimated average concentration of the averaged biotin-avidin, biotin-neutravidin, and biotin-MEG is 33.7 nM, 21.4 nm, and 12.0 nm respectively. Since the MEG and MEG:N₃AT concentrations are much higher, they mask some of the avidin signals.

Another explanation for the low SERS signal for Avidin may be explained by the SERS effect. Two mechanisms that are used to explain the SERS effect are charge transfer and electromagnetism. The electromagnetic mechanism occurs by an electromagnetic field enhancement caused by a plasmon excitation through the incident laser on metal surfaces (Hering et al., Anal. Bioanal. Chem. 2008, 390:113). Charge transfer occurs through a charge transfer process between the adsorbed analyte and the metal surface (Campion et al., Chem. Soc. Rev. 1998, 27:241). These methods work simultaneously to contribute to the overall enhancement. A requirement for the charge transfer effect is that the molecules are in direct with the surface of the gold nanoparticles. Therefore, the first monolayer which consist of MEG or MEG:N₃AT will have higher enhancements than the clicked biotin and avidin, which are further from the surface (Sarkar et al., Chem. Phys. Lett. 1992, 190:59). It has been shown that electromagnetic enhancements decrease exponentially with increasing chain length for groups chemically bound to roughened surfaces (Kennedy et al., J. Phys. Chem. B 1999, 103:3640). Hence, molecules closer to the surface will experience greater electromagnetic enhancements that those further away.

These observations can be seen in several ways be examining the SERS spectra. The avidin spectrum shows well defined spectral bands. This sample was prepared by adding avidin to bare gold nanoparticles. Hence, the avidin molecules are in direct contact with the gold nanoparticles, therefore avidin bands are enhanced greatly enhanced. If the spacer is added first and then avidin, there is a noticeable reduction in bands for avidin, which is due to its signal being masked by the MEG. In the spectra where avidin is added after biotynlation, there is a significant reduction in the signals for avidin.

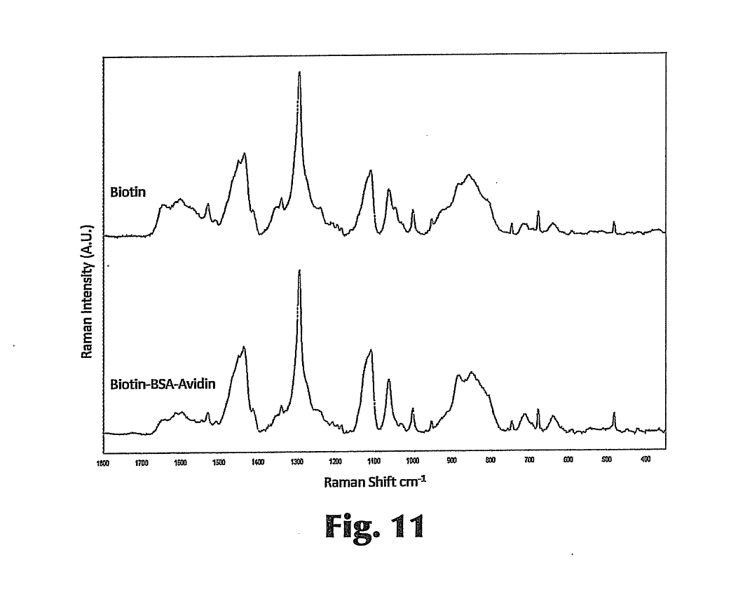

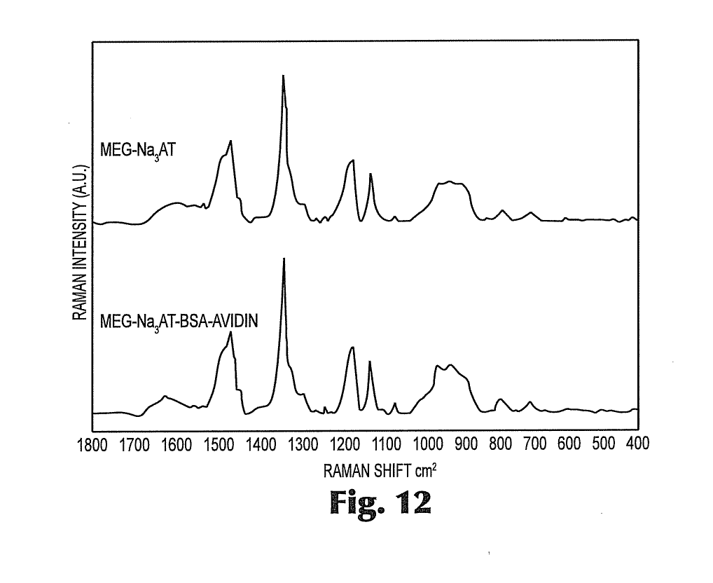

One final experiment included the use of Bovine Serum Albumin (BSA) as an agent to block avidin from binding to the surface of the gold nanoparticles. BSA has a similar molecular weight to avidin, no specific reaction with biotin, and is commonly used to block nonspecific interactions in ELISA procedures (Yam et al., J. Colloid Interface Sci. 2002, 245:204). BSA was purchased from Thermo Scientific. A solution of BSA was added to the nanoparticles after biotinylation. After purification by centrifugation, avidin was then added to the nanoparticles. These samples were analyzed by fluorescence and SERS. The fluorescence response for the biotin-bsa-avidin and MEG:N₃AT-BSA-avidin nanoparticles are 208 and 74 respectively. These values are significantly lower than the biotin-avidin nanoparticles and MEG-BSA-avidin. Avidin bands in the SERS spectra of the BSA coated nanoparticles appear weaker than the spectra where BSA is not used. This suggests that BSA was able block additional binding sights on the gold nanoparticles, therefore promoting further biding to biotin. SERS spectra for these samples can be seen in FIG. 11-12.

### Chemometric Analysis

Since the SERS signals of avidin appear very weakly in the SERS spectra, chemometric methods were used for classification purposes. Classification tools used were PCA and PLS-DA. PCA is an unsupervised statistical method for analysis and classifies using total spectral variance (Hennigan et al., PLoS One 2010, 5). PCA is used to reduce dataset dimensionality, reduce noise, and maximize total spectral variance among spectral fingerprints for each sample analyzed; thereby clustering similar spectra into groups for classification (Driskell et al., PLoS One 2010, 5). Using PCA, several models were built for classification.

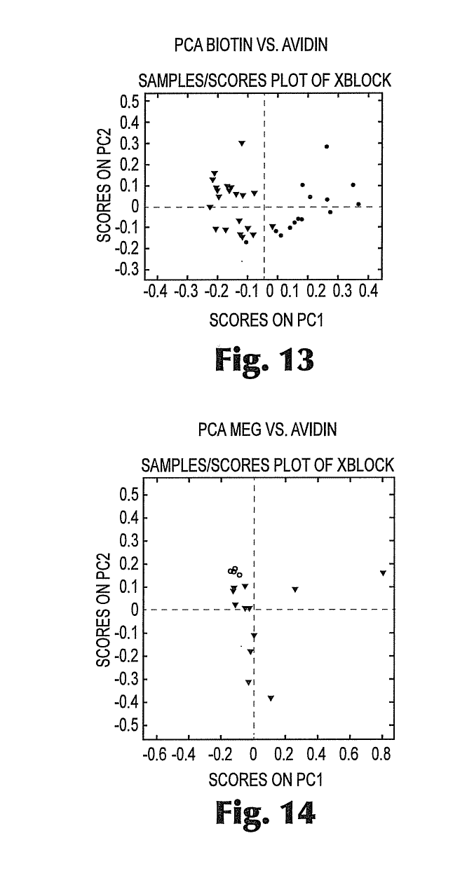

First, a model was built to classify biotin and avidin spectra. In this model, spectra of MEG:N₃AT:BDIBO were labeled as the Biotin group. Spectra of MEG:N₃AT:BDIBO-Avidin were labeled as the Biotin-Avidin group. Principal components 1 and 2 were used to compare the processed spectra of these groups. FIG. 13. shows some differentiation between the biotin and avidin groups. Another model built contained spectra of MEG, which were labeled as the Spacer group and MEG-Avidin, which was labeled as the MEG-Avidin group. Principle components 1 and 2 were also used for classification. In FIG. 14. there is some classification of the Spacer group with the Spacer-Avidin group. This is expected since avidin is not expected to significantly bind to the nanoparticles in the absence of biotin.

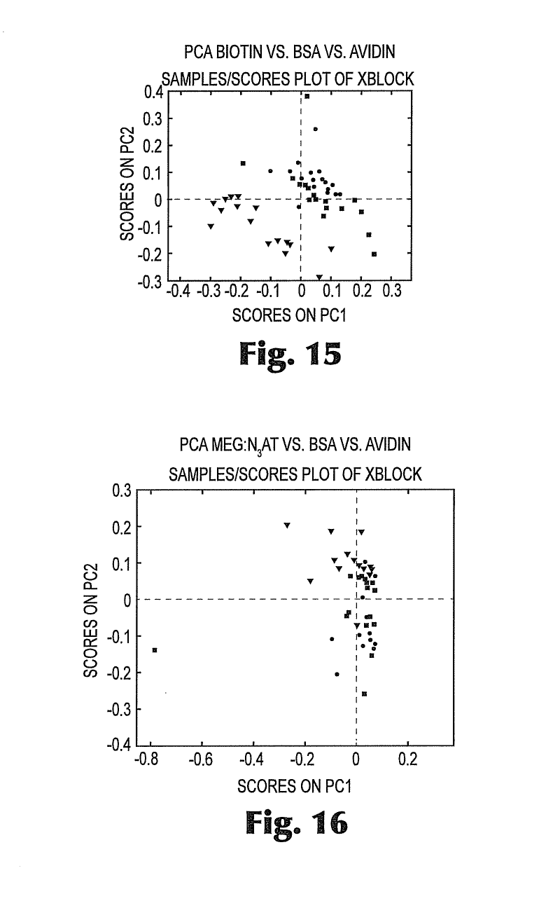

The last two models built contained the BSA spectra. This first BSA model contained MEG:N₃AT:BDIBO, MEG:N₃AT:BDIBO-BSA, and MEG:N₃AT:BDIBO-BSA-avidin. The groups were named Biotin, Biotin-BSA and Biotin-BSA-Avidin. The model was also built using principle components 1 and 2. The PCA model can be seen in FIG. 15. The figure shows that the Biotin-BSA-Avidin spectra do separate from the Biotin group. However, there is no separation from the Biotin-BSA-Avidin and Biotin-BSA. The final model analyzed by PCA included spectra of MEG:N₃AT, MEG:N₃AT-BSA, and MEG:N₃AT-BSA-Avidin. Using the same principal components, FIG. 16 shows some clustering between MEG:N₃AT and MEG:N₃AT-BSA-Avidin.

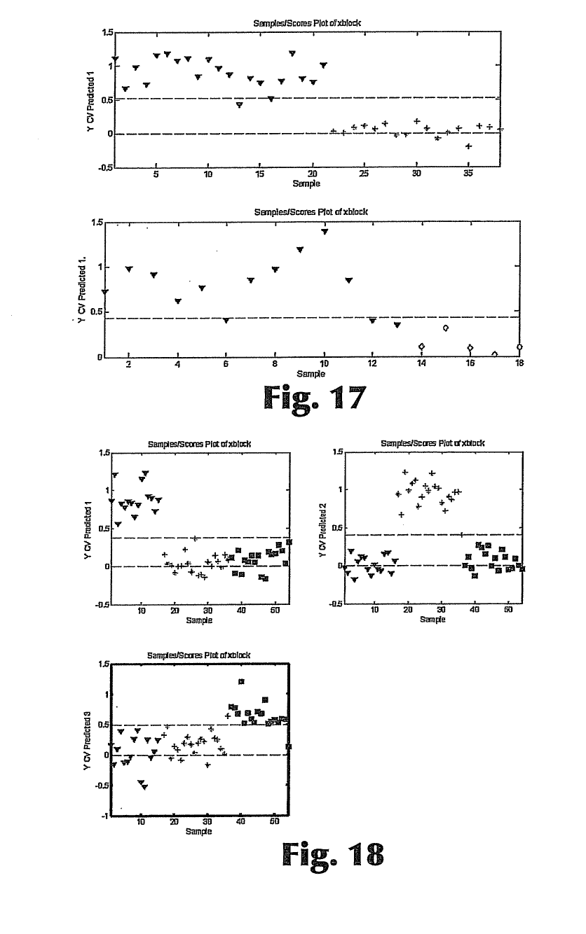

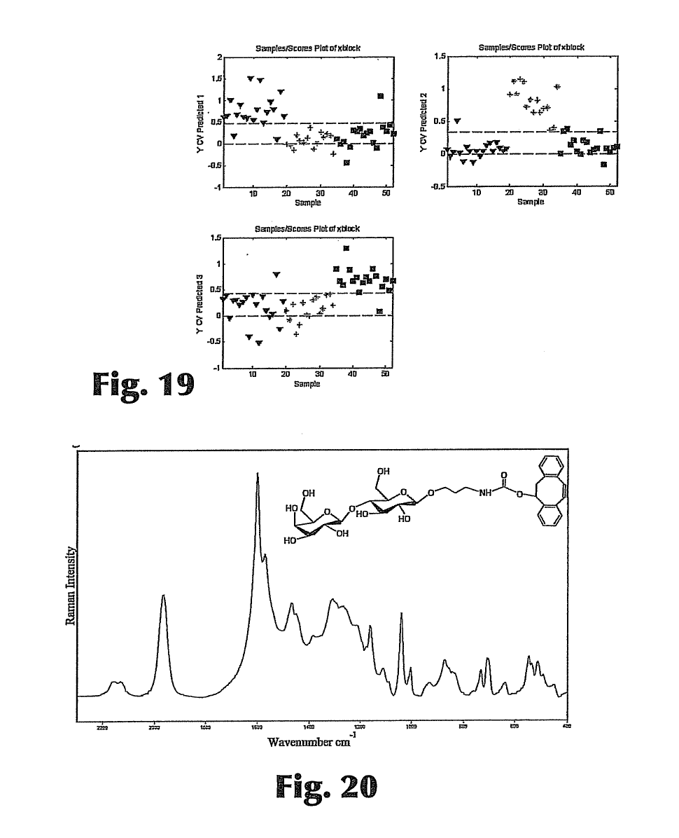

All the models built thus far were also analyzed by PLS-DA. PLS-DA is a supervised statistical method, where prior knowledge of the classes is used for classification (Hennigan et al., PLoS One 2010, 5). This method minimizes the contribution of spectral features which vary within a particular class and maximizes the contribution of spectral features which vary among the different classes (Driskell et al., PLoS One 2010, 5). PLS-DA models for the Biotin-Avidin and MEG-Avidin group can be seen in FIG. 17. PLS-DA models for the BSA experiments can be seen in FIGS. 18-19.

In the figure the threshold is plotted as the dashed line. Cross validated predictions for each model tested are shown in the figure. Class designation is determined by the separation of Y prediction values greater which will appear either above or below the threshold. For example, in the Biotin vs. Avidin model, all the values that are above the 0.5 threshold are classified as biotin and those below are classified as avidin. The PLS-DA model was evaluated for performance in terms of sensitivity and specificity. Sensitivity is defined as the number of samples assigned to the class divided by the actual number of samples belonging to the class. Specificity is defined as the number of samples not assigned to the class defined by the number of samples not belonging to the class (Driskell et al., PLoS One 2010, 5). In Tables 5-8 a summary of sensitivity and specificity results is shown. Sensitivity and Specificity values for the model created is >76%.

TABLE 5
Summary of sensitivity and specificity results from PLS-DA.

| BIOTIN vs. AVIDIN | BIOTIN | BIOTIN-AVIDIN |
|---|---|---|
| Sensitivity (CV) | 0.905 | 1.000 |
| Specificity (CV) | 1.000 | 0.905 |

TABLE 6
Summary of sensitivity and specificity results from PLS-DA.

| SPACER vs. AVIDIN | SPACER | SPACER-AVIDIN |
|---|---|---|
| Sensitivity (CV) | 0.769 | 1.000 |
| Specificity (CV) | 1.000 | 0.769 |

TABLE 7
Summary of sensitivity and specificity results from PLS-DA.

| BIOTIN vs. BSA vs. AVIDIN | BIOTIN | BSA | AVIDIN |
|---|---|---|---|
| Sensitivity (CV) | 1.000 | 0.950 | 0.889 |
| Specificity (CV) | 0.974 | 0.848 | 0.943 |

TABLE 8
Summary of sensitivity and specificity results from PLS-DA.

| MEG:N₃AT vs. BSA vs. AVIDIN | MEG:N₃AT | BSA | AVIDIN |
|---|---|---|---|
| Sensitivity (CV) | 0.895 | 1.000 | 0.889 |
| Specificity (CV) | 0.970 | 0.946 | 0.882 |

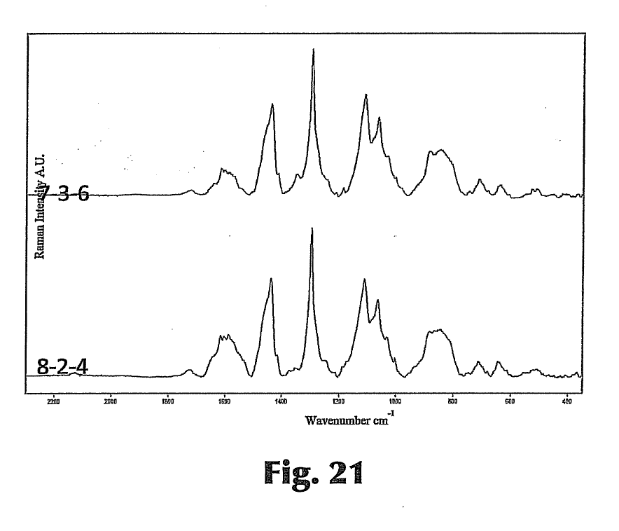

To further investigate and show how Cu(I)-free cycloaddition reactions can be applied to a wide variety of biological systems, galactose has been derivitized with DIBO. This compound and its SERS spectra can be seen in the FIG. 20 and spectral assignments can be seen in Table 9. First, azides are attached to the surface utilizing MEG/N₃AT. In the second step of the derivitizaton process, Gal-DIBO is clicked on the surface. These steps have been examined by SERS to determine useful ratios of MEG:N₃AT to use for clicking conditions. After the azides were placed onto the surface, various concentration of Gal-DIBO were added for clicking conditions and examined by SERS. The SERS spectra for the clicked products can be seen in FIG. 21.

TABLE 9
Spectral Assignments for Gal-DIBO.

| RAMAN SHIFT | |
|---|---|
| (cm⁻¹) | ASSIGNMENTS |
| 399 | endocyclic deformation bands |
| 450 | exocyclic deformation bands |
| 706 | |
| 851 | δ(COH), δ(CCH), δ(OCH) side group deformations |
| 1004 | v(C—O) and v(C—C) |
| 1039 | v(C—O) and v(C—C) |
| 1087 | v(C—O) and v(C—C) |
| 1161 | v(C—O) and v(C—C) |
| 1264 | δ(CH₂) and δ(CH₂OH) |
| 1465 | δ(CH₂) and δ(CH₂OH) |
| 1571 | Ring Stretches |
| 1599 | Ring Stretches |
| 1964 | C≡C stretch |
| 2133 | C≡C stretch |

The 7:3 and 8:2 SERS spectra of MEG:N₃AT are similar to those shown in FIG. 2 and are not shown here. Spectral comparisons between FIG. 2 and FIG. 21 show differences which are highlighted with the red boxes. These spectral differences are related to v(C—O) and v(C—C) and ring stretches found in Gal-DIBO.

In conclusion, it has been shown that copper free click chemistry can be used to examine the biotin avidin system. Avidin was successfully captured using clicked biotinylated nanoparticles. Due to the spectral uniqueness of the Cu(I)-free click chemistry reaction, SERS can be used to examine step-by step modification of the reaction. Nonspecific binding of avidin was shown to be minimal and further reduced using BSA as a blocking agent. Using chemometric analysis of SERS spectra classification of spectra according to group type was made. Preliminary studies of carbohydrate reactions utilizing Cu(I)-free cycloaddition reactions were also shown as well. These studies show Cu(I)-free click chemistry reactions coupled with SERS is well suited to study biorecognition systems. This technique can be used to build multi array technology.

The complete disclosure of all patents, patent applications, and publications, and electronically available material (e.g., GenBank amino acid and nucleotide sequence submissions; and protein data bank (pdb) submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of preparing a surface enhanced Raman spectroscopy (SERS) platform for the detection of a biomaterial, the method comprising:
providing a solid substrate comprising a surface having attached thereto a plurality of azide-functional groups; and
contacting at least a portion of the azide-functional groups with at least one cyclooctyne having a biomaterial attached thereto under conditions effective for a cycloaddition reaction to form a triazole having the biomaterial attached thereto.

2. The method of claim 1 wherein the solid substrate is in the form of a particle or rod.

3. The method of claim 2 wherein the solid substrate is in the form of a microparticle or a microrod.

4. The method of claim 1 wherein the biomaterial comprises a carbohydrate.

5. The method of claim 4 wherein the carbohydrate is a glycan.

6. The method of claim 1 wherein the cyclooctyne is a dibenzocyclooctyne.

7. The method of claim 6 wherein the dibenzocyclooctyne is of the formula: 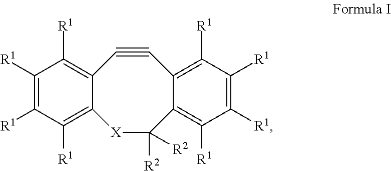
wherein:
each R¹ is independently selected from the group consisting of hydrogen, halogen, hydroxy, alkoxy, nitrate, nitrite, sulfate, and a C1-C10 organic group;
each R² is independently selected from the group consisting of hydrogen, halogen, hydroxy, alkoxy, nitrate, nitrite, sulfate, and a C1-C10 organic group;
X represents C═O, C═N—OR³, C═N—NR³R⁴, CHOR³, CHNHR³, BR³, NR³, O, SiR³R⁴, PR³, O═PR³ or halogen; and
each R³ and R⁴ independently represents hydrogen or an organic group, with the proviso that at least one R group is attached to the biomaterial.

8. The method of claim 4 wherein each R¹ represents hydrogen.

9. The method of claim 4 wherein each R² represents hydrogen.

10. The method of claim 4 wherein X represents CHOR³ and R³ is an organic linking group attached to the biomaterial.

11. A method of preparing a surface enhanced Raman spectroscopy (SERS) platform for the detection of a biomaterial, the method comprising:
providing a solid substrate comprising a surface having a plurality of triazole conjugate groups attached thereto, wherein the triazole conjugate groups are reaction products of (i) azide-functional groups attached to the surface of the substrate and (ii) cyclooctynes having a biomaterial binding group attached thereto; and
contacting the biomaterial binding groups with the biomaterial under conditions effective to bind and immobilize the biomaterial.

12. The method of claim 11 wherein the solid substrate is in the form of a particle or rod.

13. The method of claim 12 wherein the solid substrate is in the form of a microparticle or a microrod.

14. The method of claim 11 wherein the biomaterial binding group comprises a carbohydrate binding group and the biomaterial comprises a carbohydrate.

15. The method of claim 14 wherein the carbohydrate is a glycan.

16. The method of claim 14 wherein the carbohydrate is bound using affinity binding.

17. The method of claim 16 wherein the carbohydrate binding group comprises a biotin group, and the carbohydrate comprises avidin and/or streptavidin.

18. The method of claim 11 wherein the cyclooctyne is a dibenzocyclooctyne.

19. The method of claim 18 wherein the dibenzocyclooctyne is of the formula: 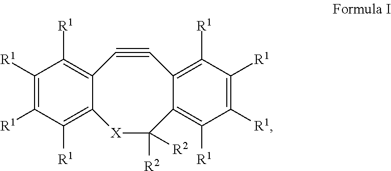
wherein:
each R¹ is independently selected from the group consisting of hydrogen, halogen, hydroxy, alkoxy, nitrate, nitrite, sulfate, and a C1-C10 organic group;
each R² is independently selected from the group consisting of hydrogen, halogen, hydroxy, alkoxy, nitrate, nitrite, sulfate, and a C₁-C₁₀ organic group;
X represents C═O, C═N—OR³, C═N—NR³R⁴, CHOR³, CHNHR³, BR³, NR³, O, SiR³R⁴, PR³, O═PR³ or halogen; and
each R³ and R⁴ independently represents hydrogen or an organic group, with the proviso that at least one R group is attached to the biomaterial binding group.

20. The method of claim 19 wherein X represents CHOR³ and R³ is an organic linking group attached to the biomaterial binding group.

21. A surface enhanced Raman spectroscopy (SERS) platform comprising:
a solid substrate comprising a surface; and
a plurality of triazole conjugate groups attached to the surface, wherein the triazole conjugate groups are reaction products of (i) azide-functional groups attached to the surface of the substrate and (ii) cyclooctynes having a biomaterial attached thereto.

22. The surface enhanced Raman spectroscopy (SERS) platform of claim 21 wherein the solid substrate comprises a polymer, a glass, a metal, a plastic, an oxide, or combinations thereof.

23. The surface enhanced Raman spectroscopy (SERS) platform of claim 21 wherein the solid substrate is in the form of a particle or rod.

24. The surface enhanced Raman spectroscopy (SERS) platform of claim 23 wherein the solid substrate is in the form of a microparticle or a microrod.

25. The surface enhanced Raman spectroscopy (SERS) platform of claim 21 wherein the biomaterial comprises carbohydrates.

26. The surface enhanced Raman spectroscopy (SERS) platform of claim 25 wherein at least a portion of the carbohydrates are glycans.

27. The surface enhanced Raman spectroscopy (SERS) platform of claim 21 wherein the platform is a microarray comprising two or more different biomaterials.

28. The surface enhanced Raman spectroscopy (SERS) platform of claim 21 wherein the cyclooctynes are dibenzocyclooctynes.

29. The surface enhanced Raman spectroscopy (SERS) platform of claim 21 further comprising a plurality of polar groups and/or a plurality of hydrophobic groups attached to the surface.

30. The surface enhanced Raman spectroscopy (SERS) platform of claim 29 wherein the polar groups are polyethylene glycol-containing groups.

31. The surface enhanced Raman spectroscopy (SERS) platform of claim 29 wherein the hydrophobic groups comprise C1-C30 hydrocarbon-containing groups.

32. A method of detecting an immobilized biomaterial, the method comprising:
providing a surface enhanced Raman spectroscopy (SERS) platform according to claim 21; and
detecting the biomaterial using surface enhanced Raman spectroscopy.

33. The method of claim 32 wherein the biomaterial comprises a carbohydrate.

34. The method of claim 33 wherein the carbohydrate is a glycan.

35. The method of claim 32 wherein detection of the biomaterial provides data for the diagnosis of a disease or state.
